(19) United States
(12) Patent Application Publication
(10) Pub. No.: US 2025/0341857 A1
(43) Pub. Date: Nov. 6, 2025

(54) TOUCH SOUND PRODUCTION DISPLAY UNIT AND DEVICE

(71) Applicant: AUDFLY TECHNOLOGY (SUZHOU) CO., LTD., Jiangsu (CN)

(72) Inventors: Yayun HU, Jiangsu (CN); Zheng KUANG, Jiangsu (CN); Junwei MAO, Jiangsu (CN)

(73) Assignee: AUDFLY TECHNOLOGY (SUZHOU) CO., LTD., Jiangsu (CN)

(21) Appl. No.: 18/868,779

(22) PCT Filed: May 10, 2023
(86) PCT No.: PCT/CN2023/093239

§ 371 Date: Nov. 25, 2024

(30) Foreign Application Priority Data
May 25, 2022 (CN) 202210577959.6
May 25, 2022 (CN) 202210587376.1

(51) Int. Cl. G06F 1/16; G06F 3/041; G06F 3/14

(52) U.S. Cl. CPC G06F 1/1605; G06F 3/041; G06F 3/1446

(57) ABSTRACT

The present invention discloses a touch sound production display unit and device. The unit includes a first substrate, a functional area, and a second substrate sequentially laminated from top to bottom, the functional area includes a touch area and a sound production area, the touch area and the sound production area are located between the first substrate and the second substrate and are spaced apart from each other in a horizontal direction, the first substrate and the second substrate are shared by the touch area and the sound production area, and the sound production area is an electrostatic ultrasonic transducer. In the present invention, the electrostatic ultrasonic transducer is combined with a touch screen, so that the display device can achieve screen directional sound production and achieve touch in a non-interfering manner.

### TECHNICAL FIELD

The present invention relates to the field of screen directional sound production technologies, and specifically, to a touch sound production display unit and device.

### BACKGROUND

Ultra-thin, narrow-bezel, and even full-screen designs of display devices leave less space for acoustic devices. Conventional acoustic devices have a large volume and positions for mounting such conventional acoustic devices are limited, making it difficult to find positions and space for mounting such the conventional acoustic devices in new-generation display devices. Therefore, it is necessary to redesign an acoustic device to adapt to current needs of display devices.

Some display device manufacturers have developed a scheme of sound production using a screen. The screen sound production technology is a surface audio technology that provides a new solution for speakers of multimedia audio and video devices. Currently, a transparent screen directional speaker that combines a display device with a screen sound production device is being developed, which uses vibration of a screen is used as a speaker to save space of a resonance cavity of a conventional speaker, and has a directional propagation characteristic that meets protect the privacy of personal electronic devices and prevent devices of different people from interfering with each other.

A touch panel can recognize a touch point input by a hand or a separate input unit, and transfer information corresponding to the touch point to the display device. According to touch sensing methods, touch panels are classified into resistive, capacitive, and infrared sensing touch panels. Capacitive touch panels currently receive widespread attention due to a simple manufacturing method and high screen sensitivity.

How to combine screen directional sound production with a touch function to enable a display to integrate a plurality of functions such as screen directional sound production, display, and touch in a non-interfering manner is a problem that needs to be resolved at present.

### SUMMARY OF INVENTION

An objective of the present invention is to provide a touch sound production display unit and device that can simultaneously achieve a touch function and a screen directional sound production function.

To achieve the foregoing objective, according to an aspect, the present invention provides a touch sound production display unit. The unit includes a first substrate, a functional area, and a second substrate sequentially laminated from top to bottom, the functional area includes a touch area and a sound production area, the touch area and the sound production area are located between the first substrate and the second substrate and are spaced apart from each other in a horizontal direction, the first substrate and the second substrate are shared by the touch area and the sound production area, and the sound production area is an electrostatic ultrasonic transducer.

In a preferred embodiment, the electrostatic ultrasonic transducer includes a first electrode, a second electrode, and a microstructure, where the first electrode is formed on a part of a lower end surface of the first substrate opposite to the second substrate, the second electrode is formed on a part of an upper end surface of the second substrate opposite to the first substrate, the microstructure is formed between the first electrode and the second electrode and is configured to provide an air gap required for vibration and sound production of a sound production layer, and bezel bonding is performed on outer edges of the first substrate and the second substrate located in the sound production area.

In a preferred embodiment, the first electrode includes a first conductive layer and a first edge conductive layer, and the second electrode includes a second conductive layer and a second edge conductive layer, where the first conductive layer is formed on the part of the lower end surface of the first substrate opposite to the second substrate, and the first edge conductive layer is formed on an edge of at least one side of the first conductive layer located on the sound production area; and the second conductive layer is formed on the part of the upper end surface of the second substrate opposite to the first substrate, and the second edge conductive layer is formed on an edge of at least one side of the second conductive layer located on the sound production area.

In a preferred embodiment, the electrostatic ultrasonic transducer further includes an insulation layer, where the insulation layer includes a first insulation layer and a first edge insulation layer, the first insulation layer is formed on the part of the upper end surface of the second substrate opposite to the first substrate and covers at least the second conductive layer and the second edge conductive layer, the microstructure is formed on the first insulation layer, and the first edge insulation layer is formed on the part of the lower end surface of the first substrate opposite to the second substrate and covers at least the first edge conductive layer.

In a preferred embodiment, the touch area includes a third conductive layer and a fourth conductive layer, where the third conductive layer is formed on a part of the lower end surface of the first substrate opposite to the second substrate, and is spaced apart from the first conductive layer; and the fourth conductive layer is formed on a part of the upper end surface of the second substrate opposite to the first substrate, and is spaced apart from the first conductive layer.

In a preferred embodiment, a lower end surface of the third conductive layer is flush with a lower end surface of the first conductive layer, and the third conductive layer and the first conductive layer are insulated and spaced apart from each other through a first spacer area; and a lower end surface of the fourth conductive layer is flush with a lower end surface of the second conductive layer, and the fourth conductive layer and the second conductive layer are insulated and spaced apart from each other through a second spacer area.

Preferably, the third conductive layer and the fourth conductive layer are bonded through an adhesive, and a thickness of the adhesive is the same as a thickness between the first conductive layer and the second conductive layer.

Preferably, sheet resistance of the third conductive layer is higher than sheet resistance of the first conductive layer, and sheet resistance of the fourth conductive layer is higher than sheet resistance of the second conductive layer.

Preferably, the first conductive layer and the second conductive layer each are made of a conductive material with sheet resistance of 10Ω or less, and the third conductive layer and the fourth conductive layer each are made of a conductive material with sheet resistance of 100Ω to 150Ω or less.

Preferably, the first substrate and the second substrate are polyethylene terephthalate (PET) films, a thickness of the first substrate ranges from 20 μm to 25 μm, a thickness of the second substrate ranges from 50 μm to 55 μm, and widths of the first spacer area and the second spacer area are 20 μm or less. A smaller width indicates a better visualization effect.

According to another aspect, the present invention provides a touch sound production display device, including at least one touch sound production display unit or a plurality of touch sound production display units spliced together.

Compared with the prior art, the present invention has the following beneficial effects:
1. In the present invention, an electrostatic ultrasonic transducer is combined with a touch screen, so that a display device can achieve screen directional sound production and achieve touch in a non-interfering manner. In this way, when the screen directional sound production is achieved, listening is private, and interference to surrounding personnel is avoided, the display device also has a touch function, and an application range of the display device is expanded, for example, the display device can be used in a vehicle.
2. In the present invention, through use of two substrate layers, combination of corresponding preparation processes, and cooperation of different material parameters, an audible sound pressure level of the formed display device at 1 KHz can reach 70 db to 80 db.

### BRIEF DESCRIPTION OF THE DRAWINGS

FIG. 1 is a schematic structural diagram of a touch sound production display unit according to the present invention;

FIG. 2 is a schematic structural diagram of a touch sound production display unit according to an embodiment of the present invention;

FIG. 3 is a schematic structural diagram of a sound production layer according to an embodiment of the present invention;

FIG. 4 is a schematic diagram of a partitioned structure of a touch sound production display device (having one touch sound production display unit) according to the present invention;

FIG. 5 is a schematic diagram of a partitioned structure of a touch sound production display device (having two touch sound production display units spliced together) according to the present invention; and

FIG. 6 is a flowchart of a preparation process according to the present invention.

### REFERENCE NUMERALS

1—first substrate, 2—sound production area, 21—first electrode, 211—first conductive layer, 212—first edge conductive layer, 22—second electrode, 221—second conductive layer, 222—second edge conductive layer, 23—microstructure, 24—insulation layer, 241—first insulation layer, 242—first edge insulation layer, 3—touch area, 31—third conductive layer, 32—fourth conductive layer, 4—second substrate, 5—first spacer area, 6—second spacer area, 7—edge fixing area, and 8—adhesive.

### DETAILED DESCRIPTION

The following describes specific implementations of the present invention in detail, but it should be understood that the protection scope of the present invention is not limited to the specific implementations.

Unless otherwise explicitly stated, throughout the specification and claims, the term “include” or variations thereof such as “comprise” or “including” will be understood to include the stated elements or components but not exclude other elements or other components.

In a touch sound production display unit and device disclosed in the present invention, an electrostatic ultrasonic transducer is combined with a touch screen, so that the display device can achieve screen directional sound production and achieve touch in a non-interfering manner. In this way, when the screen directional sound production is achieved, listening is private, and interference to surrounding personnel is avoided, the display device also has a touch function, and an application range of the display device is expanded, for example, the display device can be used in a vehicle.

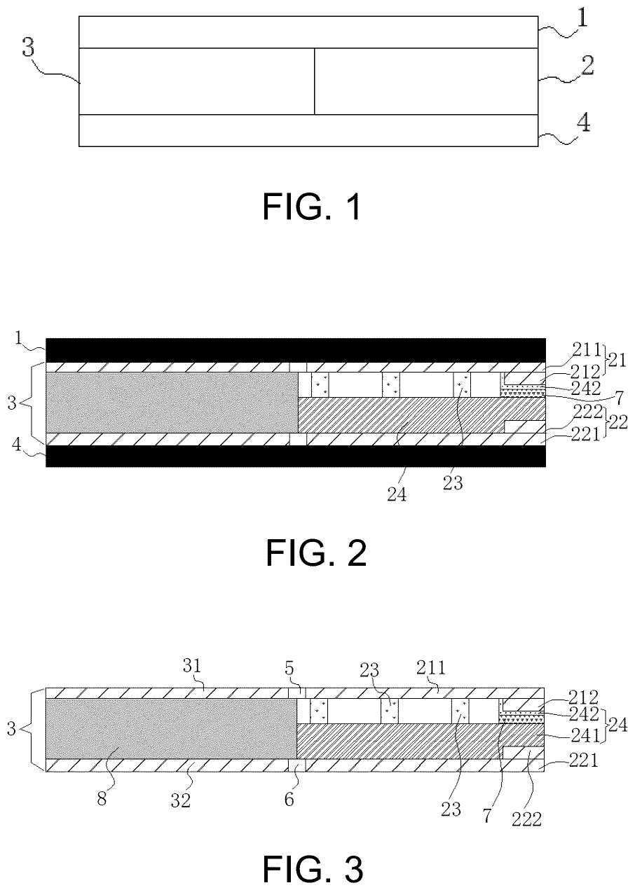

As shown in FIG. 1, a touch sound production display unit disclosed in an embodiment of the present invention discloses includes a first substrate 1, a functional area, and a second substrate 4 sequentially laminated from top to bottom. The functional area includes a sound production area 2 and a touch area 3 spaced apart from each other. In other words, the first substrate 1, the functional area, and the second substrate 4 cooperate to form a touch unit on one side and a sound production unit on the other side, so that a display screen can simultaneously achieve touch display and achieve directional sound production in a non-interfering manner.

Specifically, the first substrate 1 is located on an uppermost layer, and may be made of a PET material commonly used in the touch field, or may be made of a transparent polyimide film (CPI)/a polyimide film (PI)/an ultra-thin glass (UTG). A lower thickness of the first substrate 1 indicates higher sound production efficiency. A preferred thickness of the first substrate 1 may range from 6 μm to 50 μm, and a common thickness of the first substrate 1 is 6 μm, 12 μm, 21 μm, 23 μm, 25 μm, or 50 μm. The second substrate 4 is located on a lowermost layer, and may also be made of the PET material commonly used in the touch field, glass, or the like. A common thickness of the second substrate 4 is 50 μm.

With reference to FIG. 2 and FIG. 3, the touch area 3 and the sound production area 2 are located between the first substrate 1 and the second substrate 4 and are spaced apart from each other left and right. The sound production area 2 is an electrostatic ultrasonic transducer, which specifically includes a first electrode 21, a second electrode 22, a microstructure 23, and an insulation layer 24. The first electrode 21 includes a first conductive layer 211 and a first edge conductive layer 212. The touch area 3 includes a third conductive layer 31 and a fourth conductive layer 32. The third conductive layer 31 and the first conductive layer 211 are formed on a lower end surface of the first substrate 1, are respectively located on left and right sides of the lower end surface of the first substrate 1, and are spaced apart through a first spacer area 5. During preparation, a conductive layer is first plated on a left half of the lower end surface of the first substrate 1, then a conductive layer is plated on a right half of the lower end surface of the first substrate 1, and then the first spacer area 5 is etched or photo-etched in a middle area between the two conductive layers, where the first spacer area 5 is a conductive layer-free area. In this way, the conductive layer on the left side forms the third conductive layer 31, and the conductive layer on the right side forms the first conductive layer 211. In addition, sheet coating may alternatively be used. Specifically, an area on the lower end surface of the first substrate 1 on which the third conductive layer 31 is to be plated is first coated (certainly, an area on which the first conductive layer 211 is to be plated may alternatively be coated, and the sequence is not limited), and then a conductive layer is plated on the area on which the first conductive layer 211 is to be plated, to form the first conductive layer 211. Then, the coated area is exposed through tearing, and a target material is replaced to plate a conductive layer on another area (that is, plate the third conductive layer 31).

Sheet resistance of a conductive layer required for touch is different from sheet resistance of a conductive layer required for sound production. Therefore, preferably, sheet resistance of the third conductive layer 31 is set to be inconsistent with sheet resistance of the first conductive layer 211, and preferably, the sheet resistance of the third conductive layer 31 is higher than the sheet resistance of the first conductive layer 211. Certainly, if the touch is compatible with a low-resistance material, the sheet resistance of the third conductive layer 31 may also be selected to be the same as the sheet resistance of the first conductive layer 211. In this way, when a conductive layer is plated, coil coating may be implemented, that is, conductive layers with same sheet resistance may be entirely plated on the lower end surface of the first substrate 1. Lower sheet resistance of a conductive layer of the sound production area 2 (that is, the first conductive layer 211 herein) is more conducive to improving sound production efficiency. Preferably, a conductive material with sheet resistance of 10Ω or less is used.

The first edge conductive layer 212 is at least formed on an edge of the first conductive layer 211. To be specific, the first edge conductive layer 212 may be arranged only around an outer edge of the first conductive layer 211 (where an edge adjacent to one side of the first spacer area 5 on the left side may be excepted). A right half of the first substrate 1, the first conductive layer 211, and the first edge conductive layer 212 form a vibration layer of the sound production unit.

The second electrode 22 includes a second conductive layer 221 and a second edge conductive layer 222. The fourth conductive layer 32 and the second conductive layer 221 are formed on an upper end surface of the second substrate 4, are respectively located on left and right sides of the upper end surface of the second substrate 4, and are spaced apart through a second spacer area 6. Same as the process of preparing the fourth conductive layer 32 and the second conductive layer 221, during the preparation, a conductive layer is first plated on a left half of the upper end surface of the second substrate 4, then a conductive layer is plated on a right half of the upper end surface of the second substrate 4, and then the second spacer area 6 is etched or photo-etched in a middle area between the two conductive layers, where the second spacer area 6 is a conductive layer-free area. In this way, the conductive layer on the left side forms the fourth conductive layer 32, and the conductive layer on the right side forms the second conductive layer 221. In addition, sheet coating may alternatively be used. Specifically, an area on the upper end surface of the second substrate 4 on which the fourth conductive layer 32 is to be plated is first coated (certainly, an area on which the second conductive layer 221 is to be plated may alternatively be coated, and the sequence is not limited), and then a conductive layer is plated on the area on which the second conductive layer 221 is to be plated, to form the second conductive layer 221. Then, the coated area is exposed through tearing, and a target material is replaced to plate a conductive layer on another area (that is, plate the fourth conductive layer 32). During implementation, widths of the first spacer area and the second spacer area are 20 μm or less, and a thickness of an adhesive 8 is 25 μm or less.

Similarly, sheet resistance of a conductive layer required for the touch is different from sheet resistance of a conductive layer required for the sound production. Therefore, preferably, sheet resistance of the fourth conductive layer 32 is set to be inconsistent with sheet resistance of the second conductive layer 221, and preferably, the sheet resistance of the fourth conductive layer 32 is higher than the sheet resistance of the second conductive layer 221. Certainly, if the touch is compatible with a low-resistance material, the sheet resistance of the fourth conductive layer 32 may also be selected to be the same as the sheet resistance of the second conductive layer 221. In this way, when a conductive layer is plated, coil coating may be implemented, that is, conductive layers with same sheet resistance may be entirely plated on the upper end surface of the second substrate 4. Lower sheet resistance of a conductive layer of the sound production area (that is, the second conductive layer 221 herein) is more conducive to improving the sound production efficiency. Preferably, a conductive material with sheet resistance of 10Ω or less is used.

The second edge conductive layer 212 is at least formed on an edge of the second conductive layer 221. To be specific, the second edge conductive layer 222 may be arranged only around an outer edge of the second conductive layer 221 (where an edge adjacent to one side of the second spacer area 6 on the left side may be excepted).

The insulation layer 24 specifically includes a first insulation layer 241 and a first edge insulation layer 242. The first insulation layer 241 is formed on the upper end surface of the second substrate 4 opposite to the first substrate 1 and covers at least the second conductive layer 221 and the second edge conductive layer 222. In this embodiment, the first insulation layer 241 covers the second conductive layer 221 and the second edge conductive layer 222. The first edge insulation layer 242 is formed on the lower end surface of the first substrate 1 opposite to the second substrate 4 and covers at least the first edge conductive layer 212. In this embodiment, the first edge insulation layer 242 covers the first edge conductive layer 212. In other embodiments, the insulation layer may alternatively have another alternative structure. For example, the insulation layer may alternatively be arranged on the entire lower end surface of the first substrate 1 and the entire upper end surface of the second substrate 4, or the edge insulation layer only covering the first edge conductive layer 242 is arranged on the upper end surface of the second substrate 4, as long as insulation between the first conductive layer 211 and the second conductive layer 221 can be achieved. During implementation, a thickness of the first insulation layer 241 may range from 5 μm to 15 μm.

The microstructure 23 is arranged between the first conductive layer 211 and the second conductive layer 221, and may be arranged on the lower end surface of the first substrate 1 or the upper end surface of the second substrate 4. When the microstructure 23 is arranged on the upper end surface of the second substrate 4, the microstructure 23 is specifically arranged on an upper end surface of the first insulation layer 241. During implementation, the microstructure 23 is preferably arranged on the upper end surface of the first insulation layer 241. During implementation, a thickness of the microstructure 23 may range from 12 μm to 18 μm or 80 μm to 100 μm.

The second substrate 4, the second conductive layer 221, the second edge conductive layer 222, the first insulation layer 241, and the microstructure 23 form a non-vibration layer of the sound production unit. Bezel bonding is used between the vibration layer and the non-vibration layer of the sound production unit. Specifically, bezel bonding is performed between a lower end surface of the first conductive layer 211 and the upper end surface of the first insulation layer 241. In this embodiment, an edge fixing area 7 is arranged on an outer edge of the first insulation layer 241, and the edge fixing area 7 specifically includes a fixing area (not shown in the figure) located on an outer side and a non-fixing area (not shown in the figure) located on an inner side, where a double-sided adhesive may be used in the fixing area, and silicone, a UV adhesive, or the like may be used in the non-fixing area.

In addition, the third conductive layer 31 and the fourth conductive layer 32 are fully bonded through the adhesive 8, and the thickness of the adhesive 8 is preferably equal to a thickness between the first conductive layer 211 and the second conductive layer 221, so that heights of the left and right areas can be balanced. Matching of the heights of the left and right areas is conducive to maximizing flatness of the visible area of the display unit and maximizing the sound production efficiency. During implementation, the thickness of the adhesive 8 is 30 μm or less, and preferably ranges from 25 μm to 30 μm.

During implementation, the first conductive layer 211 and the second conductive layer 221 each may be preferably made of a superconducting material. Lower sheet resistance is more conducive to improving the sound production efficiency. Preferably, a conductive material with sheet resistance of 10Ω or less is used. The third conductive layer 31 and the fourth conductive layer 32 each may be made of a conductive material with sheet resistance of 100Ω to 150Ω or less, and are generally made of a conductive material with sheet resistance of 150Ω or 100Ω.

In addition, in the foregoing solution, the first substrate 1, the touch area 3, the sound production area 2, and the second substrate 4 cooperate to form one half as the touch unit, and the other half as the sound production unit. In other words, the touch unit is located on the left side, and the sound production unit is located on the right side. In this way, a left half of the integrally formed touch sound production display unit is a touch part, and a right half is a sound production part. The two parts are spaced apart from each other in a left-right direction, so that functions of the two parts can be independent of each other and do not interfere with each other.

In a specific embodiment, the first substrate 1 is made of the PET material with the thickness of 23 μm, which matches the first conductive layer 211 and the second conductive layer 221 with the sheet resistance of 102Ω the microstructure 23 with the thickness of 12 μm to 18 μm or 80 μm to 100 μm, and the first insulation layer 241 with the thickness of 5 μm to 15 μm. A sound pressure at 1 KHz may reach 70 db to 80 db.

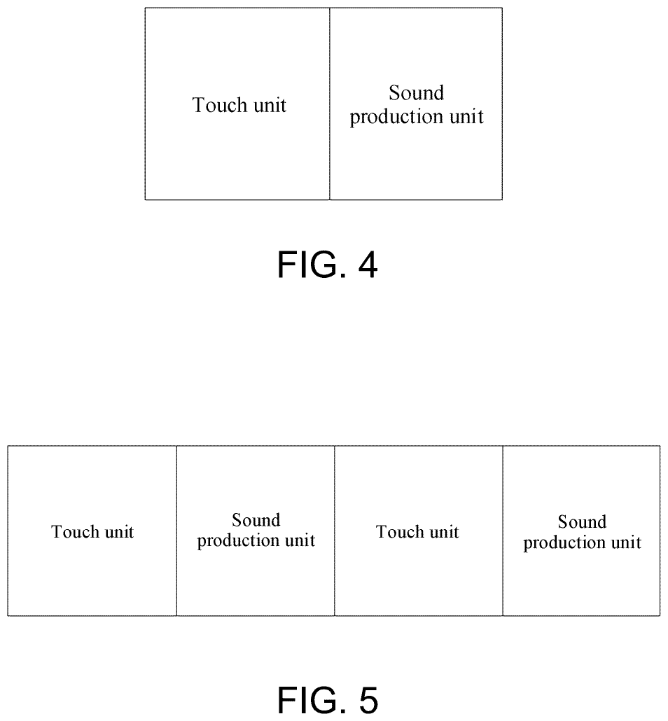

With reference to FIG. 4 and FIG. 5, the present invention further provides a touch sound production display device. The touch sound production display unit includes at least one touch sound production display unit, where one half of one display unit may be used for touch, and the other half may be used for sound production. The touch sound production display unit may alternatively include a plurality of touch sound production display units spliced together, and a plurality of touch areas and a plurality of sound production areas may be formed after splicing. A quantity of touch sound production display units and a splicing manner may be selected as required. For example, when the unit is used in a vehicle, one touch sound production display unit may be arranged for a main driving seat, or one display unit may be arranged for each of a front passenger seat and rear seats, so that touch and sound production can be implemented on each seat.

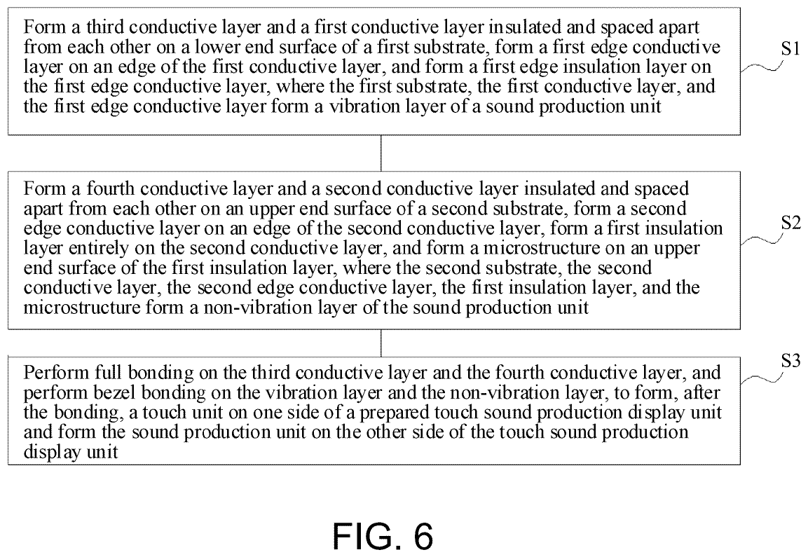

According to another aspect, as shown in FIG. 6, a process of preparing a touch sound production display unit disclosed in the present invention includes the following steps:

S1: Form a third conductive layer and a first conductive layer insulated and spaced apart from each other on a lower end surface of a first substrate, form a first edge conductive layer on an edge of the first conductive layer, and form a first edge insulation layer on the first edge conductive layer, where the first substrate, the first conductive layer, and the first edge conductive layer form a vibration layer of a sound production unit.

In this embodiment, specifically, a conductive layer is first plated on a left half of the lower end surface of a first substrate 1, then a conductive layer is plated on a right half of the lower end surface of the first substrate 1, and then a first spacer area 5 is etched or photo-etched in a middle area between the two conductive layers, where the first spacer area 5 is a conductive layer-free area. In this way, the conductive layer on the left side forms a third conductive layer 31, and the conductive layer on the right side forms a first conductive layer 211. In addition, sheet coating may alternatively be used. Specifically, an area on the lower end surface of the first substrate 1 on which the third conductive layer 31 is to be plated is first coated (certainly, an area on which the first conductive layer 211 is to be plated may alternatively be coated, and the sequence is not limited), and then a conductive layer is plated on the area on which the first conductive layer 211 is to be plated, to form the first conductive layer 211. Then, the coated area is exposed through tearing, and a target material is replaced to plate a conductive layer on another area (that is, plate the third conductive layer 31). Then, the first edge conductive layer is formed on the edge of the first conductive layer.

S2: Form a fourth conductive layer and a second conductive layer insulated and spaced apart from each other on an upper end surface of a second substrate, form a second edge conductive layer on an edge of the second conductive layer, form a first insulation layer entirely on the second conductive layer, and form a microstructure on an upper end surface of the first insulation layer, where the second substrate, the second conductive layer, the second edge conductive layer, the first insulation layer, and the microstructure form a non-vibration layer of the sound production unit.

Specifically, in this embodiment, same as the process of forming the conductive layer on the first substrate, during the preparation, a conductive layer is first plated on a left half of the upper end surface of a second substrate 4, then a conductive layer is plated on a right half of the upper end surface of the second substrate 4, and then a second spacer area 6 is etched or photo-etched in a middle area between the two conductive layers, where the second spacer area 6 is a conductive layer-free area. In this way, the conductive layer on the left side forms a fourth conductive layer 32, and the conductive layer on the right side forms a second conductive layer 221. In addition, sheet coating may alternatively be used. Specifically, an area on the upper end surface of the second substrate 4 on which the fourth conductive layer 32 is to be plated is first coated (certainly, an area on which the second conductive layer 221 is to be plated may alternatively be coated, and the sequence is not limited), and then a conductive layer is plated on the area on which the second conductive layer 221 is to be plated, to form the second conductive layer 221. Then, the coated area is exposed through tearing, and a target material is replaced to plate a conductive layer on another area to form the fourth conductive layer 32 (that is, plate the fourth conductive layer 32). Then, a second edge conductive layer 212 is formed on the edge of the second conductive layer 221, the first insulation layer 241 covering the second edge conductive layer 212 and the second conductive layer 221 is formed on the second conductive layer 221, and the microstructure 23 is formed on the first insulation layer 241.

S3: Perform full bonding on the third conductive layer and the fourth conductive layer, and perform bezel bonding on the vibration layer and the non-vibration layer, to form, after the bonding, a touch unit on one side of the prepared touch sound production display unit and form the sound production unit on the other side of the touch sound production display unit.

Specifically, in this embodiment, the third conductive layer 31 and the fourth conductive layer 32 are fully bonded through an adhesive 8, and a thickness of the adhesive 8 is preferably equal to a thickness between the first conductive layer 211 and the second conductive layer 221. Bezel bonding is used between the vibration layer and the non-vibration layer of the sound production unit. Specifically, bezel bonding is performed between the lower end surface of the first conductive layer 211 and the upper end surface of the first insulation layer 241, so that an air gap required for vibration of the vibration layer is formed between the vibration layer and the non-vibration layer.

Preferably, when the first substrate and the second substrate are bonded, the first substrate and the second substrate may be tightly bonded by using a heating tightening process or a jig tightening process. For a specific tightening process, reference may be made to description of a tightening process of a vibration layer of a directional sound production display screen filed with the prior application No. CN202210469615.3. Details are not described herein again.

Advantages of the present invention are as follows: 1. In the present invention, an electrostatic ultrasonic transducer is combined with a touch screen, so that a display device can achieve screen directional sound production and achieve touch in a non-interfering manner. In this way, when the screen directional sound production is achieved, listening is private, and interference to surrounding personnel is avoided, the display device also has a touch function, and an application range of the display device is expanded, for example, the display device can be used in a vehicle. 3. In the present invention, through use of two substrate layers, combination of corresponding preparation processes, and cooperation of different material parameters, an audible sound pressure level of the formed display device at 1 KHz can reach 70 db to 80 db.

The foregoing descriptions of specific exemplary embodiments of the present invention are for the objective of description and illustration. The descriptions are not intended to limit the present invention to the precise form disclosed, and apparently, many changes and variations may be made based on the above teachings. The exemplary embodiments are selected and described for the objective of explaining particular principles of the present invention and practical applications thereof, so that a person skilled in the art can implement and use various exemplary implementations of the present invention and various choices and changes. The scope of the present invention is defined by the claims and equivalents thereof.

1. A touch sound production display unit,
comprising a first substrate, a functional area, and a second substrate sequentially laminated from top to bottom, the functional area comprises a touch area and a sound production area, the touch area and the sound production area are located between the first substrate and the second substrate and are spaced apart from each other in a horizontal direction, the first substrate and the second substrate are shared by the touch area and the sound production area, and the sound production area is an electrostatic ultrasonic transducer.

2. The touch sound production display unit according to claim 1, wherein the electrostatic ultrasonic transducer comprises a first electrode, a second electrode, and a microstructure, wherein the first electrode is formed on a part of a lower end surface of the first substrate opposite to the second substrate, the second electrode is formed on a part of an upper end surface of the second substrate opposite to the first substrate, the microstructure is formed between the first electrode and the second electrode, and is configured to provide an air gap required for vibration and sound production of a sound production layer, and bezel bonding is performed on outer edges of the first substrate and the second substrate located in the sound production area.

3. The touch sound production display unit according to claim 2, wherein the first electrode comprises a first conductive layer and a first edge conductive layer, and the second electrode comprises a second conductive layer and a second edge conductive layer, wherein the first conductive layer is formed on the part of the lower end surface of the first substrate opposite to the second substrate, and the first edge conductive layer is formed on an edge of at least one side of the first conductive layer located on the sound production area; and the second conductive layer is formed on the part of the upper end surface of the second substrate opposite to the first substrate, and the second edge conductive layer is formed on an edge of at least one side of the second conductive layer located on the sound production area.

4. The touch sound production display unit according to claim 3, wherein the electrostatic ultrasonic transducer further comprises an insulation layer, wherein the insulation layer comprises a first insulation layer and a first edge insulation layer, the first insulation layer is formed on the part of the upper end surface of the second substrate opposite to the first substrate and covers at least the second conductive layer and the second edge conductive layer, the microstructure is formed on the first insulation layer, and the first edge insulation layer is formed on the part of the lower end surface of the first substrate opposite to the second substrate and covers at least the first edge conductive layer.

5. The touch sound production display unit according to claim 3, wherein the touch area comprises a third conductive layer and a fourth conductive layer, wherein the third conductive layer is formed on the part of the lower end surface of the first substrate opposite to the second substrate, and is spaced apart from the first conductive layer in the horizontal direction; and the fourth conductive layer is formed on the part of the upper end surface of the second substrate opposite to the first substrate, and is spaced apart from the first conductive layer in the horizontal direction.

6. The touch sound production display unit according to claim 5, wherein a lower end surface of the third conductive layer is flush with a lower end surface of the first conductive layer, and the third conductive layer and the first conductive layer are insulated and spaced apart from each other through a first spacer area; and a lower end surface of the fourth conductive layer is flush with a lower end surface of the second conductive layer, and the fourth conductive layer and the second conductive layer are insulated and spaced apart from each other through a second spacer area.

7. The touch sound production display unit according to claim 6, wherein the third conductive layer and the fourth conductive layer are bonded through an adhesive, and a thickness of the adhesive is the same as a distance between the first conductive layer and the second conductive layer.

8. The touch sound production display unit according to claim 5, wherein sheet resistance of the third conductive layer is higher than sheet resistance of the first conductive layer, and sheet resistance of the fourth conductive layer is higher than sheet resistance of the second conductive layer.

9. The touch sound production display unit according to claim 7, wherein the first substrate and the second substrate are polyethylene terephthalate films, a thickness of the first substrate ranges from 20 μm to 25 μm, a thickness of the second substrate ranges from 50 μm to 55 μm, widths of the first spacer area and the second spacer area are 20 μm or less, and the thickness of the adhesive is 30 μm or less.

10. A touch sound production display device, comprising the touch sound production display unit according to claim 1 or a plurality of touch sound production display units according to claim 1 spliced together.

11. A touch sound production display device, comprising the touch sound production display unit according to claim 2 or a plurality of touch sound production display units according to claim 2 spliced together.

12. A touch sound production display device, comprising the touch sound production display unit according to claim 3 or a plurality of touch sound production display units according to claim 3 spliced together.

13. A touch sound production display device, comprising the touch sound production display unit according to claim 4 or a plurality of touch sound production display units according to claim 4 spliced together.

14. A touch sound production display device, comprising the touch sound production display unit according to claim 5 or a plurality of touch sound production display units according to claim 5 spliced together.

15. A touch sound production display device, comprising the touch sound production display unit according to claim 6 or a plurality of touch sound production display units according to claim 6 spliced together.

16. A touch sound production display device, comprising the touch sound production display unit according to claim 7 or a plurality of touch sound production display units according to claim 7 spliced together.

17. A touch sound production display device, comprising the touch sound production display unit according to claim 8 or a plurality of touch sound production display units according to claim 8 spliced together.

18. A touch sound production display device, comprising the touch sound production display unit according to claim 9 or a plurality of touch sound production display units according to claim 9 spliced together.
